(19) United States
(12) Patent Application Publication
(10) Pub. No.: US 2026/0064621 A1
(43) Pub. Date: Mar. 5, 2026

(54) AUDIO RECORDING METHOD WITH LOSS-MITIGATING BUFFER SYSTEM

(71) Applicant: SHURE ACQUISITION HOLDINGS, INC., Niles, IL (US)

(72) Inventor: Ali Eerikki Ahmaniemi, Tampere (FI)

(21) Appl. No.: 19/312,929

(22) Filed: Aug. 28, 2025

Related U.S. Application Data
(60) Provisional application No. 63/688,908, filed on Aug. 30, 2024.

(51) Int. Cl. G06F 13/42; G06F 11/14; G06F 13/16

(52) U.S. Cl. CPC G06F 13/4204; G06F 11/1471; G06F 13/1673

(57) ABSTRACT

The present disclosure provides an audio recording apparatus comprising at least one processor and a memory storing instructions that, when executed by the processor, cause the apparatus to receive audio data, write a minimum loss segment of the audio data to a minimum loss definition buffer, and execute a parallel write operation upon completing the writing of the minimum loss segment to the minimum loss definition buffer. The parallel write operation comprises writing the minimum loss segment to a minimum loss segment recovery file and writing the minimum loss segment to a storage latency reduction buffer. The apparatus provides efficient audio recording while minimizing potential data loss through the use of multiple buffers and parallel write operations.

### CROSS REFERENCE TO RELATED APPLICATIONS

This application claims the benefit of U.S. Provisional Patent Application No. 63/688,908, titled “AUDIO RECORDING METHOD WITH LOSS-MITIGATING BUFFER SYSTEM,” and filed on Aug. 30, 2024, the entirety of which is hereby incorporated by reference.

### FIELD

The present disclosure relates to audio recording systems and methods, and more particularly to an audio recording method that is configured to reduce audio loss risk while optimizing audio storage efficiency.

### BACKGROUND

An audio system may utilize an array of microphones in an audio environment to capture audio data. However, existing techniques for capturing, recording, and/or storing audio data are prone to audio loss and/or computational inefficiencies.

### SUMMARY

Various embodiments of the present disclosure are directed to apparatuses, systems, methods, and computer readable media for audio recording and storage optimization. These characteristics as well as additional features, functions, and details of various embodiments are described below. The claims set forth herein further serve as a summary of this disclosure.

### BRIEF DESCRIPTION OF FIGURES

Having thus described some embodiments in general terms, reference will now be made to the accompanying drawings, which are not necessarily drawn to scale, and wherein:

FIG. 1 illustrates a block diagram of an audio recording apparatus, according to aspects of the present disclosure.

FIG. 2A illustrates example operations for audio recording involving a minimum loss definition buffer and a storage latency reduction buffer, according to an embodiment.

FIG. 2B illustrates continuing example operations from those illustrated in FIG. 2A for audio recording involving a minimum loss definition buffer and a storage latency reduction buffer, according to an embodiment.

FIG. 3 illustrates a flowchart for an audio data recording process, according to aspects of the present disclosure.

FIG. 4 illustrates a flowchart for an audio data recording process, according to aspects of the present disclosure.

FIG. 5 is a schematic block diagram illustrating an example audio recording apparatus, according to aspects of the present disclosure.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

The present disclosure relates to an improved method and apparatus for audio recording that provides robust failsafe capabilities while optimizing system performance. Example technical challenges addressed by embodiments of the invention include minimizing potential audio data loss in the event of recording application crashes, reducing computational overhead from frequent audio file storage operations, and balancing memory usage with recording reliability. These improvements are particularly advantageous given that many digital audio workstations do not have robust crash recovery/corrections routines.

According to an aspect of the present disclosure, an audio recording apparatus is provided. The audio recording apparatus is configured to receive audio data, write a minimum loss segment of the audio data to a minimum loss definition buffer, and execute a parallel write operation upon completing the writing of the minimum loss segment. This parallel write operation comprises writing the minimum loss segment to both a minimum loss segment recovery file and a storage latency reduction buffer.

Various embodiments of the invention leverage a multi-buffer approach with strategically timed write operations to provide audio failsafe redundancy while minimizing system impact. By utilizing short-duration minimum loss segments (e.g., 5 second segments) alongside a longer storage latency reduction buffer (e.g., a 60 second buffer), the system can efficiently manage audio data with reduced risk of loss.

According to other aspects of the disclosure, the audio recording apparatus may be further configured to delete the minimum loss segment from the minimum loss definition buffer after executing the parallel write operation. This allows for efficient buffer management. The process may be repeated for subsequent audio segments, with a merged loss segment recovery file created when the storage latency reduction buffer is filled or satisfies a buffer completion threshold. Upon creating the merged loss segment recovery file, the individual minimum loss segment recovery files may be deleted to conserve storage space.

The disclosed approach provides various advantages including: 1) limiting potential audio loss to a defined short duration (e.g., minimum loss segments) in recording application crash scenarios, 2) reducing file storage operation frequency to improve system performance, 3) optimizing audio data storage usage through strategic buffer management and file merging, and 4) maintaining recording quality by separating high-priority audio capture from lower-priority file merger and storage operations.

While various embodiments discussed herein refer to audio recording methods, systems, and apparatuses for illustration purposes, one of ordinary skill in the art will appreciate that the inventive concepts herein described are broadly applicable to various recording applications adapted for other continuous data streams such as video. The flexible buffer sizing allows for customization based on specific use case requirements around data loss tolerance, memory constraints, and computational resources.

### Example Audio Recording Apparatus and Methods

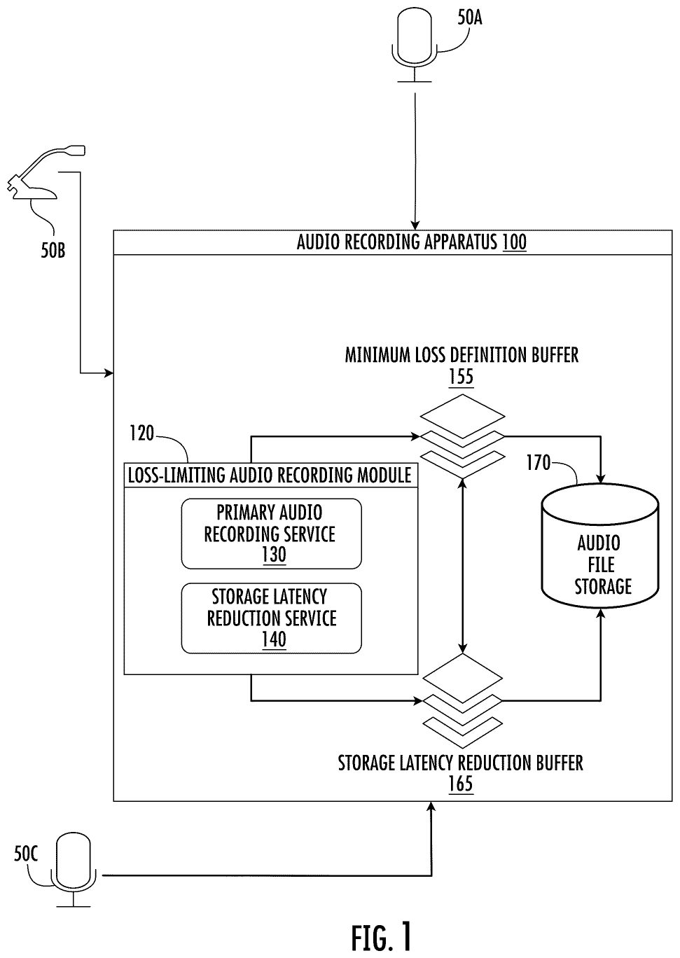

FIG. 1 depicts an example audio recording apparatus 100 configured according to various embodiments of the invention. The depicted audio recording apparatus 100 comprises at least one processor and a memory storing instructions that, when executed by the processor, cause the apparatus to perform various operations. The audio recording apparatus 100 is configured to receive audio data from multiple sources. In some cases, the audio data may be received from multiple microphones, such as microphone 50A, microphone 50B, and microphone 50C.

The audio recording apparatus 100 includes a loss-limiting audio recording module 120. The loss-limiting audio recording module 120 comprises a primary audio recording service 130 and a storage latency reduction service 140. The primary audio recording service 130 is configured to parse received audio data and to write a minimum loss segment of the audio data to a minimum loss definition buffer 455. The storage latency reduction service 140 is configured to monitor the minimum loss definition buffer and to execute a parallel write operation once a minimum loss segment has been successfully written to the minimum loss definition buffer 455.

The parallel write operation comprises writing the minimum loss segment to a minimum loss segment recovery file in an audio file storage 170 and writing the minimum loss segment to a storage latency reduction buffer 165. The storage latency reduction buffer 165 and the minimum loss definition buffer 455 are part of the memory of the audio recording apparatus 100.

The audio recording apparatus 100 is designed to minimize potential data loss and reduce storage latency by utilizing these dual buffer systems and by executing parallel write operations. The combined use of a minimum loss definition buffer 455 and a storage latency reduction buffer 165, along with executing selected parallel operations, enables the audio recording apparatus 100 to balance immediate data preservation with efficient long-term storage management.

In some aspects, the minimum loss definition buffer 455 and the storage latency reduction buffer 165 may be configured as FIFO (First-In-First-Out) arrays of five-second buffers or buffer slots. Each of the five-second buffers may be filled by the primary audio recording service 130 with respective minimum loss segments extracted from a received audio data sample.

In some cases, the storage latency reduction service 140 is configured to monitor the minimum loss definition buffer 455 to identify when a full five-second buffer has been filled with a minimum loss segment. Upon identifying a full five-second buffer, the storage latency reduction service 140 is configured to perform a parallel write operation. This operation may include writing the minimum loss segment of the filled five-second buffer to a minimum loss segment recovery file in the audio file storage 170, and appending the minimum loss segment of the filled five-second buffer to the storage latency reduction buffer 165.

In some embodiments, the storage latency reduction buffer 165 may be configured as a sixty-second buffer. When this sixty-second buffer has been filled with 12 five-second minimum loss segments, the storage latency reduction service 140 is configured to write the contents to a merged loss segment recovery file and clear the storage latency reduction buffer 165. Additionally, the storage latency reduction service 140 is also configured to delete all previous five-second minimum loss segment recovery files that were stored to the audio file storage 170 during preceding parallel write operations.

The depicted audio recording apparatus 100 is configured to operate in a continuous cycle, with the primary audio recording service 130 constantly and iteratively filling five-second buffers of the minimum loss definition buffer 455. The storage latency reduction service monitors the minimum loss definition buffer 455 to process and manage each newly written minimum loss segment for longer-term storage in the audio file storage 170.

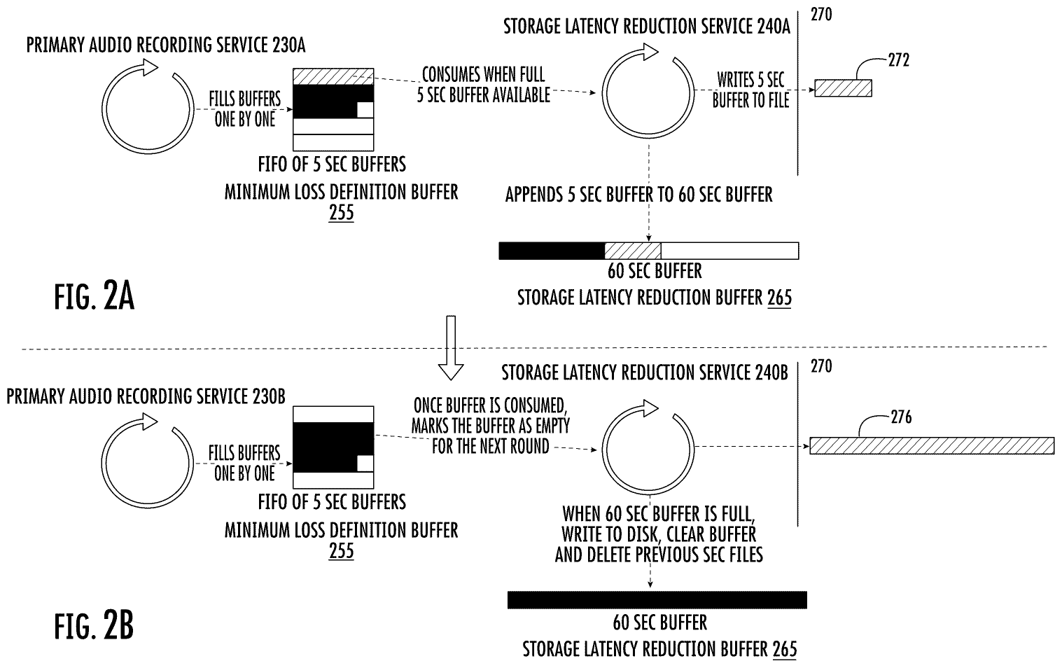

FIGS. 2A-2B illustrate process flow illustrations of operations performed by an audio recording apparatus configured in accordance with various embodiments of the invention. FIG. 2A illustrates continued operation of: an example primary audio recording service 230A to fill a minimum loss definition buffer 255, and an example storage latency reduction service 240A to fill a storage latency reduction buffer 265. FIG. 2B illustrates continued operation of the primary audio recording service 230B and the storage latency reduction service 240B while illustrating merger and audio file storage write operations triggered by the storage latency reduction buffer reaching a buffer completion threshold as discussed in greater detail below.

The depicted primary audio recording service 230A writes a minimum loss segment of the audio data to the minimum loss definition buffer 255. The minimum loss definition buffer 255 is configured as a FIFO array of five-second buffer storage slots. Each of these slots is successively filled with a minimum loss segment of the audio data by the primary audio recording service 230A.

Once a minimum loss segment has been successfully written to the minimum loss definition buffer 255, the storage latency reduction service 240A executes a parallel write operation. This parallel write operation involves two simultaneous actions. First, the minimum loss segment is written to a minimum loss segment recovery file 272 in the audio file storage system 270. Second, the same minimum loss segment is written to the storage latency reduction buffer 265.

The depicted storage latency reduction buffer 265 is configured as a sixty-second buffer. This storage latency reduction buffer 265 is successively filled with minimum loss segments from the minimum loss definition buffer 255. The storage latency reduction service 240A monitors the minimum loss definition buffer 255 to identify when a full five-second buffer slot has been filled with a minimum loss segment. Upon identifying a full five-second buffer, the storage latency reduction service 240A performs the parallel write operation.

In some embodiments, the minimum loss definition buffer 255 and the storage latency reduction buffer 265 may be configured with different buffer storage slot durations. For instance, the minimum loss definition buffer 255 may comprise a plurality of buffer storage slots each having a duration other than five seconds, such as one second, two seconds, or ten seconds. Such configurations would require minimum loss segments of one second, two seconds, or ten seconds, respectively. Similarly, the storage latency reduction buffer 265 may be configured with buffer storage slots that differ from 5-seconds and which, when aggregated, produce a buffer capacity different than sixty-seconds. For example, the storage latency reduction buffer 265 could have a total buffer capacity of thirty-30 seconds, two minutes, or five minutes. The specific durations of the buffer storage slots in the minimum loss definition buffer 255 and the storage latency reduction buffer 265 may be selected based on various factors, such as the specific requirements of the audio recording application, the available memory resources, and the desired balance between data loss tolerance and storage efficiency.

The depicted storage latency reduction buffer 265 has a sixty second capacity and is successively filled with 12 minimum loss segments by the storage latency reduction service 240A, 240B. Once the sixty second capacity of the storage latency reduction buffer 265 has been reached, i.e., a buffer completion threshold has been reached, the storage latency reduction service 240B writes the contents of the storage latency reduction buffer 265 to a merged loss segment recovery file 276 as shown in FIG. 2B. The depicted merged loss segment recovery file 276 is a single file that contains the merged audio data from the 12 minimum loss segments that were stored in the storage latency reduction buffer 265.

After writing the contents of the storage latency reduction buffer 265 to the merged loss segment recovery file 276, the storage latency reduction service 240B clears the storage latency reduction buffer 265. This operation prepares the storage latency reduction buffer 265 for receiving and storing new minimum loss segments from the minimum loss definition buffer 255.

In some embodiments, the storage latency reduction service 240B may also delete the 12 minimum loss segment recovery files 272 that correspond to the minimum loss segments that were merged into the merged loss segment recovery file 276. This operation further optimizes storage efficiency by removing redundant files from the audio file storage system 270.

The described operations of the storage latency reduction service 240A, 240B provide a robust and efficient method for managing audio data in the audio recording system. By utilizing a storage latency reduction buffer 265 and creating merged loss segment recovery files 276, the system can efficiently manage audio data with reduced risk of loss and optimized storage efficiency. For example, should the audio recording apparatus experience an application crash during the operations illustrated by FIG. 2A, the recording apparatus is configured to ensure that recorded audio loss is limited to only the minimum loss segment that is actively being written to the minimum loss definition buffer 255 and/or the storage latency reduction buffer 265. All other minimum loss segments remain available as minimum loss segment recovery files 272 and/or merged loss segment recovery files 276 in audio file storage 270.

Notably, audio recovery computational expense is considerably reduced by the creation of merged loss segment recovery files 276 because the audio recording apparatus need open a single file to access sixty seconds of recovered audio data as compared to opening twelve files to access a similar amount of recovered audio data if such were permanently stored in the form of five second minimum loss segment recovery files 272. Storing a single merged loss segment recovery file 276 also presents greater storage efficiency when compared to storing twelve minimum loss segment recovery files 272 as will be apparent to one of ordinary skill in the art.

The computational overhead or expense associated with the disclosed audio recording method is significantly reduced compared to other approaches that might involve frequent opening and merging of short audio clips. In the current approach, the use of a storage latency reduction buffer allows for fewer file operations, which translates to lower computational expense.

For example, when recording 5 microphones for one-hour, other methods might produce 3600 five-second files (12 files per minute×60 minutes×5 microphones). The methods proposed herein reduce this to approximately 300 files, representing only about 12% of the file operations compared to the other methods that might involve merging short audio clips.

During recording, the inventive methods proposed herein further optimize file operations. In a one-minute recording period, other approaches may require 87 file operations, including creating, writing, closing, opening, reading, and deleting short files. In contrast, the methods proposed herein might require only 51 file operations for the same period, a reduction of about 41%.

This reduction in file operations directly translates to lower CPU usage and improved system performance. The decreased computational overhead allows the audio recording system to handle longer recordings more efficiently and reduces the risk of audio dropouts or other performance-related issues during the recording process.

Moreover, the parallel write operations and the use of separate threads (e.g., the primary audio recording service and the storage latency reduction service) for audio capture and file operations ensure that the computationally expensive tasks of file management do not interfere with the critical process of audio data capture. This separation of concerns allows the system to maintain high-quality audio recording while efficiently managing storage operations in the background.

Computational overhead may also be reduced by distributing the load of file operations over time. For example, in a circumstance where several microphone audio streams are being recorded, multiple storage latency reduction services may be running simultaneously. However, the parallel write operations of such storage latency reduction services may be staggered so that file operations do not occur simultaneously for different audio channels. Such staggering or staging of file operations reduces CPU peak usage and mitigates audio dropouts.

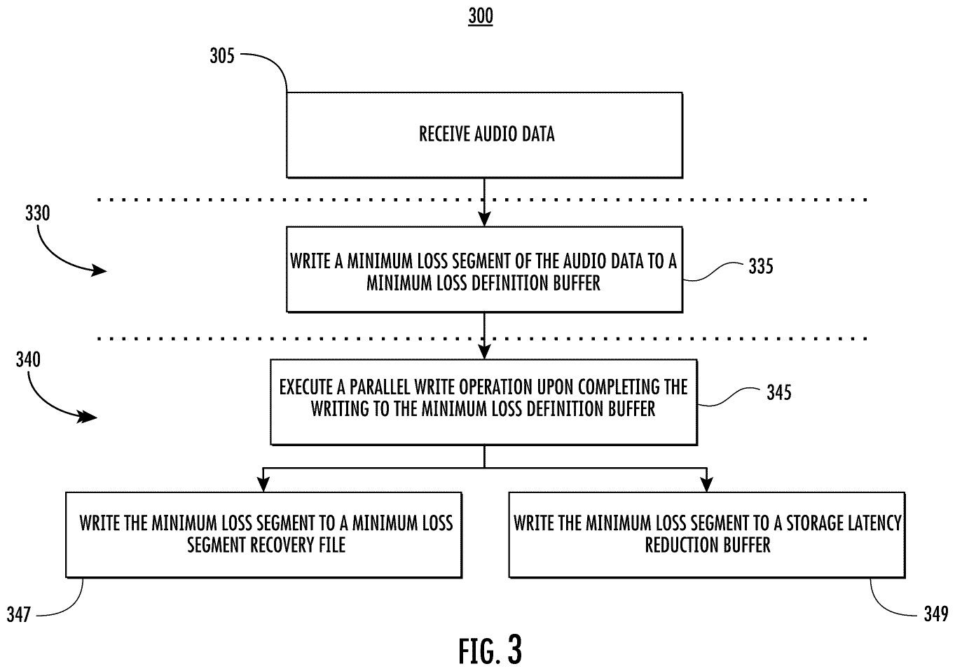

FIG. 3 depicts a method 300 for audio recording in accordance with various embodiments. The method 300 begins with receiving audio data at step 305. This audio data may be received from various sources, such as microphones, audio files, or other audio data sources. In some cases, the audio data may be received in a continuous stream, while in other cases, the audio data may be received in discrete segments or packets.

Upon receiving the audio data, the method 300 proceeds to step 335, where a minimum loss segment of the audio data is written to a minimum loss definition buffer. This step is performed by a primary audio recording service 330, which may be similar to the primary audio recording service 130 described in FIG. 1. The primary audio recording service 330 extracts a minimum loss segment from the received audio data and writes this segment to the minimum loss definition buffer. The minimum loss definition buffer may be a portion of a volatile memory, such as a random-access memory (RAM), that is used to temporarily store the minimum loss segments. The minimum loss segment buffer may also be a portion of any other memory buffer including, without limitation, some portion of processor cache memory (e.g., L2 cache, L3 cache, etc.). The minimum loss definition buffer may be configured to successively store a plurality of minimum loss segments, and the minimum loss segments may be written to the buffer in a first-in-first-out (FIFO) manner.

The minimum loss segment may be defined as a segment of the audio data that has a duration of a predetermined length that is selected to define the maximum amount of audio loss in an application crash scenario, such as five seconds. Different durations of predetermined length may be selected (e.g., 10 seconds, 20 seconds, etc.).

Upon completing the writing of the minimum loss segment to the minimum loss definition buffer, the method 300 proceeds to step 345, where a parallel write operation is executed. This parallel write operation is performed by a storage latency reduction service 340, which may be similar to the storage latency reduction service 140 described in FIG. 1.

The parallel write operation comprises two simultaneous actions. In step 347, the minimum loss segment is written to a minimum loss segment recovery file. This file may be stored in a non-volatile storage medium, such as a hard disk drive, a solid-state drive, or other types of non-volatile memory. The minimum loss segment recovery file serves as a backup copy of the minimum loss segment, which can be used to recover the audio data in case of a system crash or other failure.

Concurrently, in step 349, the same minimum loss segment is written to a storage latency reduction buffer. The storage latency reduction buffer may be a portion of a volatile memory, such as a random-access memory (RAM), that is used to temporarily store the minimum loss segment. The storage latency reduction buffer may also be a portion of any other memory buffer including, without limitation, some portion of processor cache memory (e.g., L2 cache, L3 cache, etc.). The storage latency reduction buffer may be configured to successively store a plurality of minimum loss segments up to a buffer completion threshold at which point its buffer capacity has been filled. In one embodiment, the storage latency reduction buffer defines a buffer capacity of sixty seconds.

In some aspects, the primary audio recording service 330 and the storage latency reduction service 340 may operate as separate threads within the audio recording apparatus. The primary audio recording service 330, which is responsible for writing the minimum loss segments to the minimum loss definition buffer at step 335, may be assigned a higher priority than the storage latency reduction service 340. This prioritization ensures that the audio data capture process is not interrupted or delayed by the file storage operations, thereby maintaining the quality and continuity of the recorded audio.

The storage latency reduction service 340, which performs the parallel write operations and manages the storage latency reduction buffer, may be assigned a lower priority. This service operates in the background, performing file storage operations without interfering with the primary audio recording service 330. The storage latency reduction service 340 may be designed to yield to the primary audio recording service 330 in case of resource contention, ensuring that the audio data capture process is always given precedence.

The method 300 provides a robust and efficient way of recording audio data. By writing the minimum loss segments to both a minimum loss segment recovery file and a storage latency reduction buffer simultaneously, the method 300 can ensure that the audio data is preserved with minimal loss even in the event of a system crash or other failure. Furthermore, by using a storage latency reduction buffer, the method 300 can reduce the latency associated with writing the audio data to a non-volatile storage medium, thereby improving the overall performance of the audio recording system.

The audio recording method described above is designed to handle continuous audio streams efficiently. However, in real-world scenarios, audio input may be intermittent or contain periods of silence. This section addresses how the system manages such situations.

When dealing with intermittent audio or periods of silence, the audio recording apparatus continues to operate as described, with some additional considerations. During silent periods, the primary audio recording service still writes minimum loss segments to the minimum loss definition buffer, but these segments contain silence (typically represented as zero values in uncompressed audio formats). The storage latency reduction service proceeds to execute the parallel write operation as normal, writing the silent minimum loss segments to both the minimum loss segment recovery file and the storage latency reduction buffer.

This approach ensures that the timing and synchronization of the audio stream are maintained, even when there is no actual audio content. It allows for seamless integration of audio when it resumes after a period of silence, without disrupting the overall recording structure or timing.

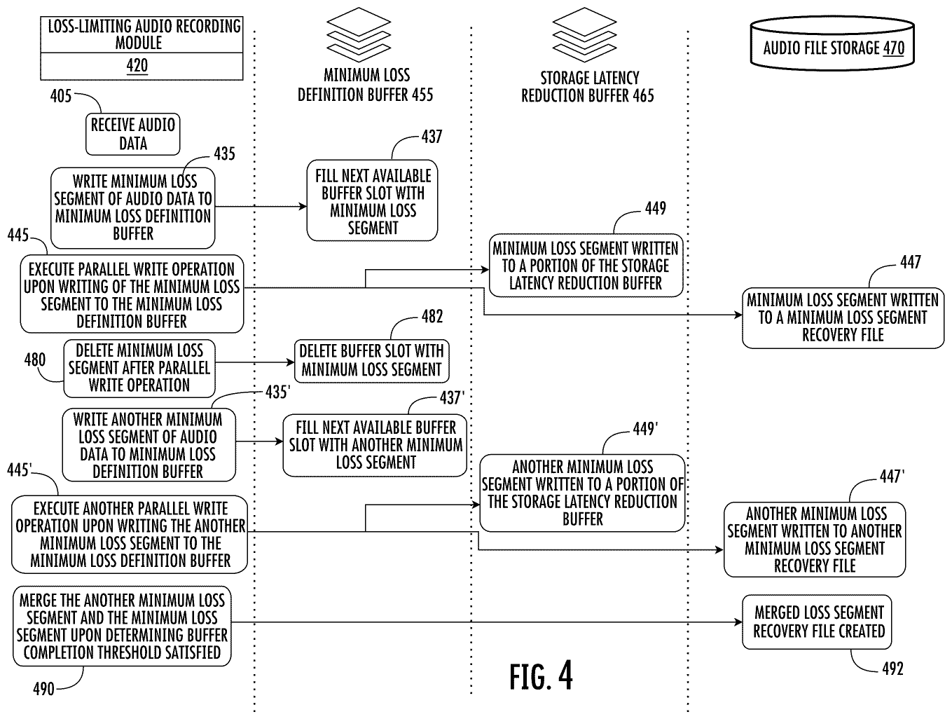

FIG. 4 is a flow diagram illustrating process operations occurring between a loss-limiting audio recording module 420, a minimum loss definition buffer 455, a storage latency reduction buffer 465, and an audio file storage 470. The process begins with the loss-limiting audio recording module 420 receiving audio data at step 405. The loss-limiting audio recording module 420 then writes a minimum loss segment of the audio data to the minimum loss definition buffer 455 at step 435. The minimum loss definition buffer 455 fills the next available buffer slot with the minimum loss segment at step 437.

Upon writing the minimum loss segment to the minimum loss definition buffer 455, the loss-limiting audio recording module 420 executes a parallel write operation at step 445. This operation involves two simultaneous actions: writing the minimum loss segment to a portion of the storage latency reduction buffer 465 at step 449 and writing the minimum loss segment to a minimum loss segment recovery file in the audio file storage 470 at step 447.

After the parallel write operation, the loss-limiting audio recording module 420 issues a deletion instruction (e.g., flags for deletion) for the minimum loss segment of the minimum loss definition buffer 455 at step 480. The minimum loss segment is deleted the minimum loss definition buffer 455 at step 482.

The process repeats with another minimum loss segment of the received audio data. The loss-limiting audio recording module 420 writes another minimum loss segment of the audio data to the minimum loss definition buffer 455 at step 435′. The minimum loss definition buffer 455 fills the next available buffer slot with the minimum loss segment at step 437′.

The loss-limiting audio recording module 420 then executes another parallel write operation at step 445′. This operation involves two simultaneous actions: writing the another minimum loss segment to a portion of the storage latency reduction buffer 465 at step 449′, and writing the another minimum loss segment to another minimum loss segment recovery file in the audio file storage 470 at step 447′.

In some aspects, the loss-limiting audio recording module 420 merges the another minimum loss segment and the minimum loss segment upon determining that a buffer completion threshold associated with the storage latency reduction buffer 465 is satisfied at step 490. This results in the creation of a merged loss segment recovery file that is stored to the audio file storage 470 at step 492. The depicted process flow illustrates the merger of two minimum loss segments (e.g., the minimum loss segment and the another minimum loss segment) but such merger may encompass a far greater number of minimum loss segments. For example, when applied to the storage latency buffer discussed in connection with FIGS. 1, 2A, and 2B above, such merger operation would encompass twelve minimum loss segments.

The process illustrated by FIG. 4 operates in a continuous cycle, processing audio data through various buffers and storage mechanisms to ensure efficient audio recording and storage. By utilizing a minimum loss definition buffer and a storage latency reduction buffer, and by executing parallel write operations, the system can efficiently manage audio data with reduced risk of loss and optimized storage efficiency.

In some embodiments, the audio recording method may be adapted to handle compressed audio formats. When dealing with compressed audio data, additional considerations may be used to maintain the integrity of the audio stream and ensure proper playback.

For compressed audio formats, the minimum loss segments cannot be arbitrarily cut at exact time intervals (e.g., 5 seconds) as this may result in incomplete frames or corrupted data. Instead, the system must be aware of the compressed audio frame boundaries. The minimum loss definition buffer and storage latency reduction buffer must be configured to store complete frames of compressed audio data.

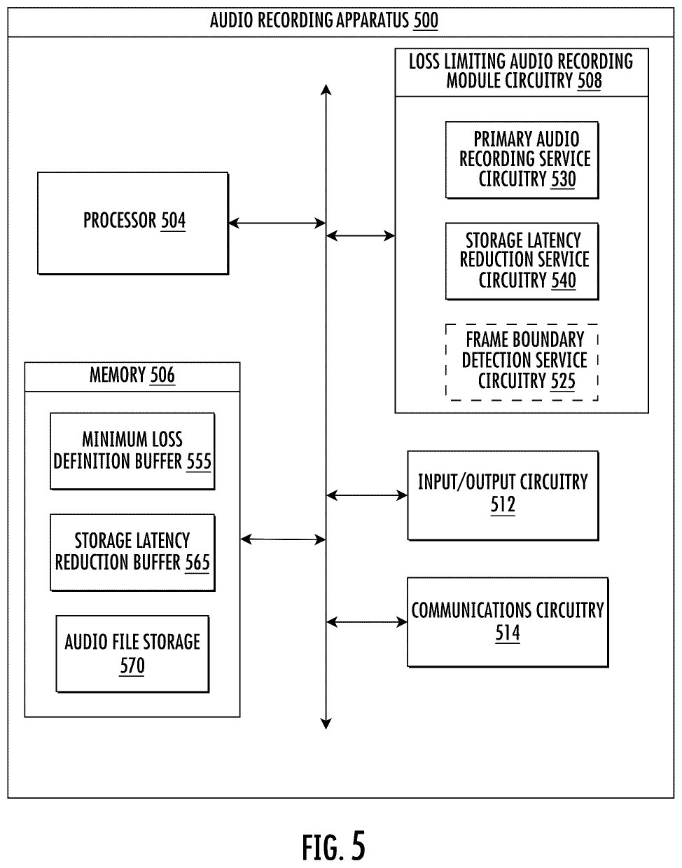

To accommodate compressed audio, the audio recording apparatus may include a frame boundary detection service (e.g., as discussed in connection with frame boundary detection service circuitry 525 in FIG. 5 below). This frame boundary detection service analyzes the incoming compressed audio stream to identify frame boundaries. The minimum loss segments are then defined based on these frame boundaries, ensuring that each segment contains only complete frames. As a result, the actual duration of each minimum loss segment may vary slightly from the target duration (e.g., 5 seconds) to align with frame boundaries.

The parallel write operation for compressed audio is also configured to be frame-aware in this embodiment. When writing to the minimum loss segment recovery file and the storage latency reduction buffer, the system ensures that only complete frames are written. This approach prevents the creation of corrupted or unplayable audio files in the event of a system crash or failure.

Additionally, when merging minimum loss segments into a merged loss segment recovery file, the system must maintain proper frame alignment and preserve any necessary header information specific to the compressed audio format. This may require additional processing to ensure seamless playback of the merged audio file.

The use of compressed audio formats can significantly reduce storage requirements compared to uncompressed audio. However, it may introduce additional computational overhead for frame boundary detection and proper handling of compressed data structures. The audio recording apparatus may be configured to balance these trade-offs based on the specific requirements of the application and available system resources.

In some cases, the disclosed audio recording method may be extended to other types of continuous data streams, such as video data. In such embodiments, the disclosed audio recording methods may be referred to as temporal data recording methods with the term “temporal data” referring to audio, video, media, some combination thereof, or any other data stream that is output, transmitted, recorded, or otherwise expressed per unit time.

Similar to audio data, video data (or any temporal data) can be divided into minimum loss segments and written to a minimum loss definition buffer. The parallel write operations can be executed to write the minimum loss segments to a minimum loss segment recovery file and a storage latency reduction buffer simultaneously. This approach can provide similar benefits for video (or temporal data) recording, including minimizing potential data loss, reducing storage latency, and optimizing system performance.

However, it should be noted that this extension to video data may consider if the received video data (i.e., temporal data) is compressed video data or uncompressed video data. As discussed above with respect to compressed audio data, compressed video data typically includes frames that cannot be arbitrarily split without causing data corruption or loss. Therefore, if the disclosed method is used with compressed video data, additional measures may be needed to identify and respect the boundaries of the compressed frames.

In still other embodiments, a temporal data recording apparatus may be configured to handle both audio and video data simultaneously. In such cases, the primary audio recording service and the storage latency reduction service may be designed to process both types of data in parallel, writing minimum loss segments of audio and video data to separate minimum loss definition buffers and storage latency reduction buffers. This dual-mode operation can provide robust and efficient recording capabilities for multimedia applications.

The temporal data or audio recording methods and apparatuses described herein have broad industrial applicability across various sectors where high-quality, reliable audio recording is essential. This invention may be particularly useful in professional audio recording studios, broadcast media production, live event audio capture, immersive audio capture applications to support sports, gaming or motion picture use cases, security and surveillance systems, audio or video conferencing, and voice recording applications for business or legal purposes. The failsafe temporal data or audio recording approach discussed above can provide important protection against data loss in mission-critical audio capture scenarios. Additionally, the efficient buffer management and storage optimization techniques make this invention well-suited for implementation in consumer electronics, mobile devices, and Internet of Things (IoT) applications where audio recording capabilities are desired but computational and storage resources may be limited. While embodiments have been described primarily in the context of audio recording, it is understood that the core concepts could be adapted for other forms of continuous temporal data stream recording, such as video or sensor data capture, expanding the potential industrial applications even further.

FIG. 5 is a schematic block diagram illustrating an example audio recording apparatus 500 configured in accordance with various embodiments of the invention. The depicted audio recording apparatus 500 comprises or is in communication with at least one processor 504, a memory 506, a loss limiting audio recording module circuitry 508, an input/output circuitry 512, and a communications circuitry 514. In some embodiments, the processor 504 (which may comprise multiple or co-processors or any other processing circuitry associated with the processor) may be in communication with the memory 506.

The memory 506 may comprise non-transitory memory circuitry and may comprise one or more volatile and/or non-volatile memories. In some examples, the memory 506 may be an electronic storage device (e.g., a computer readable storage medium) configured to store data that may be retrievable by the processor 504. In some examples, the data stored in the memory 506 may comprise audio data, stereo audio signal data, mono audio signal data, radio frequency signal data, video data, audio features, video features, or the like, for enabling the audio recording apparatus 500 to carry out various functions or methods in accordance with embodiments of the present disclosure, described herein.

The minimum loss definition buffer 555, the storage latency reduction buffer 565, and the audio file storage 570 are part of the memory 506 of the audio recording apparatus 500. The minimum loss definition buffer 555 comprises non-transitory memory circuitry that is configured to support the storage operations discussed herein in connection with the minimum loss definition buffer (e.g., minimum loss definition buffer 155). The storage latency reduction buffer 565 comprises non-transitory memory circuitry that is configured to support the storage operations discussed herein in connection with the storage latency reduction buffer (e.g., storage latency reduction buffer 165). Finally, the audio file storage 570 comprises non-transitory memory circuitry that is configured to support the storage operations discussed herein in connection with the audio file storage (e.g., audio file storage 170).

The processor 504 may be embodied in a number of different ways. For example, the processor 504 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 504 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 504 may comprise one or more processing cores configured to perform independently. A multi-core processor may enable multiprocessing within a single physical package.

Additionally or alternatively, the processor 504 may comprise one or more processors configured in tandem via a bus to enable independent execution of instructions, pipelining, and/or multithreading. In some examples, the processor 504 may be configured to execute instructions, such as computer program code or instructions, stored in the memory 506 or otherwise accessible to the processor 504.

Alternatively or additionally, the processor 504 may be configured to execute hard-coded functionality. As such, whether configured by hardware or software instructions, or by a combination thereof, the processor 504 may represent a computing entity (e.g., physically embodied in circuitry) configured to perform operations according to an embodiment of the present disclosure described herein. For example, when the processor 504 is embodied as an CPU, DSP, ARM, FPGA, ASIC, or similar, the processor may be configured as hardware for conducting the operations of an embodiment of the disclosure. Alternatively, when the processor 504 is embodied to execute software or computer program instructions, the instructions may specifically configure the processor 504 to perform the algorithms and/or operations described herein when the instructions are executed. However, in some examples, the processor 504 may be a processor of a device specifically configured to employ an embodiment of the present disclosure by further configuration of the processor using instructions for performing the algorithms and/or operations described herein. The processor 504 may further comprise a clock, an arithmetic logic unit (ALU) and logic gates configured to support operation of the processor 504, among other things.

The depicted loss limiting audio recording module circuitry 508 comprises a primary audio recording service circuitry 530, a storage latency reduction service circuitry 540, and an optional frame boundary detection service circuitry 525. The primary audio recording service circuitry 530 may be any means embodied in either hardware or a combination of hardware and software that is configured to perform one or more functions disclosed herein related to the primary audio recording service (e.g., primary audio recording service 130). The storage latency reduction service circuitry 540 may be any means embodied in either hardware or a combination of hardware and software that is configured to perform one or more functions disclosed herein related to the storage latency reduction service (e.g., storage latency reduction service 140).

The frame boundary detection service circuitry 525 is optional in that it is deployed only for compressed audio/video data formats. The frame boundary detection service circuitry 525 may be any means embodied in either hardware or a combination of hardware and software that is configured to perform one or more functions disclosed herein related to analyzing the incoming compressed audio or video stream to identify frame boundaries and making such information available to the primary audio recording service circuitry 530 and the storage latency reduction service circuitry 540 for executing frame boundary-aware: minimum loss segment write steps, parallel write operation steps, minimum loss segment merger steps, and the like.

The audio recording apparatus 500 also includes an input/output circuitry 512 and a communications circuitry 514, both connected to the processor 504. The input/output circuitry 512 allows for data input and output operations, while the communications circuitry 514 enables communication capabilities for the apparatus 500. The input/output circuitry 512 may comprise a user interface and may comprise a display. In some examples, the input/output circuitry 512 may also comprise a keyboard, a touch screen, touch areas, soft keys, buttons, knobs, or other input/output mechanisms.

The communications circuitry 514 may be any means embodied in either hardware or a combination of hardware and software that is configured to receive and/or transmit data from/to a network and/or any other device or module in communication with the audio recording apparatus 500. In this regard, the communications circuitry 514 may comprise, for example, an antennae or one or more other communication devices for enabling communications with a wired or wireless communication network. For example, the communications circuitry 514 may comprise antennae, one or more network interface cards, buses, switches, routers, modems, and supporting hardware and/or software, or any other device suitable for enabling communications via a network. Additionally or alternatively, the communications circuitry 514 may comprise the circuitry for interacting with the antenna/antennae to cause transmission of signals via the antenna/antennae or to handle receipt of signals received via the antenna/antennae.

Although example audio recording apparatuses, systems, and methods have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus.

A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, engine, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The significant elements of a computer are a processor for performing actions in accordance with instructions and one or more memory devices for storing instructions and data.

Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.
Clause 1. An apparatus comprising at least one processor and a memory storing instructions that are operable, when executed by the processor, to cause the apparatus to: receive audio data; write a minimum loss segment of the audio data to a minimum loss definition buffer; execute a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.
Clause 2. The apparatus of Clause 1, wherein the instructions are further operable to cause the apparatus to: delete the minimum loss segment from the minimum loss definition buffer upon executing the parallel write operation.
Clause 3. The apparatus of any of the aforementioned Clauses, wherein the instructions are further operable to cause the apparatus to: write another minimum loss segment of the audio data to the minimum loss definition buffer; execute another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.
Clause 4. The apparatus of any of the aforementioned Clauses, wherein the instructions are further operable to cause the apparatus to: merge the another minimum loss segment and the minimum loss segment of the storage latency reduction buffer to create a merged loss segment recovery file upon determining that the storage latency reduction buffer satisfies a buffer completion threshold.
Clause 5. The apparatus of any of the aforementioned Clauses, wherein the instructions are further operable to cause the apparatus to: delete the another minimum loss segment recovery file and the minimum loss segment recovery file upon creation of the merged loss segment recovery file.
Clause 6. The apparatus of any of the aforementioned Clauses, wherein the minimum loss definition buffer comprises a plurality of five second buffer storage slots, and wherein the minimum loss segment is written to one of the plurality of five second buffer storage slots.
Clause 7. The apparatus of any of the aforementioned Clauses, wherein the storage latency reduction buffer comprises a plurality of five second buffer storage slots, and wherein the minimum loss segment is written to one of the plurality of five second buffer storage slots.
Clause 8. The apparatus of any of the aforementioned Clauses, wherein the audio data is compressed audio data, and wherein the instructions are further operable to cause the apparatus to: detect frame boundaries in the compressed audio data; and define the minimum loss segment based on the detected frame boundaries to ensure the minimum loss segment contains only complete frames of the compressed audio data.
Clause 9. The apparatus of any of the aforementioned Clauses, wherein the instructions are further operable to cause the apparatus to: write silent minimum loss segments to the minimum loss definition buffer during periods of silence in the received audio data to maintain timing and synchronization of the audio stream.
Clause 10. The apparatus of any of the aforementioned Clauses, wherein the instructions are further operable to cause the apparatus to: execute writing of the minimum loss segment to the minimum loss definition buffer as a high-priority thread; and execute the parallel write operation as a lower-priority thread that yields to the high-priority thread in case of high computational resource demand.
Clause 11. The apparatus of any of the aforementioned Clauses, wherein the instructions are further operable to cause the apparatus to: adaptively adjust sizes of the minimum loss definition buffer and the storage latency reduction buffer based on available system resources and recording conditions.
Clause 12. A method for audio recording, comprising: receiving audio data; writing a minimum loss segment of the audio data to a minimum loss definition buffer; executing a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.
Clause 13. The method of Clause 12, further comprising: deleting the minimum loss segment from the minimum loss definition buffer upon executing the parallel write operation.
Clause 14. The method of any of the aforementioned method Clauses, further comprising: writing another minimum loss segment of the audio data to the minimum loss definition buffer; executing another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.
Clause 15. The method of any of the aforementioned method Clauses, further comprising: merging the another minimum loss segment and the minimum loss segment of the storage latency reduction buffer to create a merged loss segment recovery file upon determining that the storage latency reduction buffer satisfies a buffer completion threshold.
Clause 16. The method of any of the aforementioned method Clauses, further comprising: deleting the another minimum loss segment recovery file and the minimum loss segment recovery file upon creation of the merged loss segment recovery file.
Clause 17. The method of any of the aforementioned method Clauses, wherein the minimum loss definition buffer comprises a plurality of five second buffer storage slots, and wherein the minimum loss segment is written to one of the plurality of five second buffer storage slots.
Clause 18. The method of any of the aforementioned method Clauses, wherein the storage latency reduction buffer comprises a plurality of five second buffer storage slots, and wherein the minimum loss segment is written to one of the plurality of five second buffer storage slots.
Clause 19. The method of any of the aforementioned method Clauses, wherein the audio data is compressed audio data, and wherein the method further comprises: detecting frame boundaries in the compressed audio data; and defining the minimum loss segment based on the detected frame boundaries to ensure the minimum loss segment contains only complete frames of the compressed audio data.
Clause 20. The method of any of the aforementioned method Clauses, further comprising: writing silent minimum loss segments to the minimum loss definition buffer during periods of silence in the received audio data to maintain timing and synchronization of the audio stream.
Clause 21. The method of any of the aforementioned method Clauses, further comprising: executing writing of the minimum loss segment to the minimum loss definition buffer as a high-priority thread; and executing the parallel write operation as a lower-priority thread that yields to the high-priority thread in case of high computational resource demand.
Clause 22. The method of any of the aforementioned method Clauses, further comprising: adaptively adjusting sizes of the minimum loss definition buffer and the storage latency reduction buffer based on available system resources and recording conditions.
Clause 23. A non-transitory computer-readable medium storing instructions that, when executed by a processor, cause the processor to perform operations comprising: receiving audio data; writing a minimum loss segment of the audio data to a minimum loss definition buffer; executing a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.
Clause 24. The non-transitory computer-readable medium of Clause 23, wherein the operations further comprise: deleting the minimum loss segment from the minimum loss definition buffer upon executing the parallel write operation.
Clause 25. The non-transitory computer-readable medium of any of the aforementioned computer-readable medium Clauses, wherein the operations further comprise: writing another minimum loss segment of the audio data to the minimum loss definition buffer; executing another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.
Clause 26. The non-transitory computer-readable medium of any of the aforementioned computer-readable medium Clauses, wherein the operations further comprise: merging the another minimum loss segment and the minimum loss segment of the storage latency reduction buffer to create a merged loss segment recovery file upon determining that the storage latency reduction buffer satisfies a buffer completion threshold.
Clause 27. The non-transitory computer-readable medium of any of the aforementioned computer-readable medium Clauses, wherein the operations further comprise: deleting the another minimum loss segment recovery file and the minimum loss segment recovery file upon creation of the merged loss segment recovery file.
Clause 28. The non-transitory computer-readable medium of any of the aforementioned computer-readable medium Clauses, wherein the minimum loss definition buffer comprises a plurality of five second buffer storage slots, and wherein the minimum loss segment is written to one of the plurality of five second buffer storage slots.
Clause 29. A temporal data recording apparatus comprising at least one processor and a memory storing instructions that are operable, when executed by the processor, to cause the apparatus to: receive temporal data; write a minimum loss segment of the temporal data to a minimum loss definition buffer; execute a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.
Clause 30. The temporal data recording apparatus of Clause 29, wherein the instructions are further operable to cause the apparatus to: delete the minimum loss segment from the minimum loss definition buffer upon executing the parallel write operation.
Clause 31. The temporal data recording apparatus of any of the aforementioned temporal data recording apparatus Clauses, wherein the instructions are further operable to cause the apparatus to: write another minimum loss segment of the temporal data to the minimum loss definition buffer; execute another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.
Clause 32. The temporal data recording apparatus of any of the aforementioned temporal data recording apparatus Clauses, wherein the instructions are further operable to cause the apparatus to: merge the another minimum loss segment and the minimum loss segment of the storage latency reduction buffer to create a merged loss segment recovery file upon determining that the storage latency reduction buffer satisfies a buffer completion threshold.
Clause 33. The temporal data recording apparatus of any of the aforementioned temporal data recording apparatus Clauses, wherein the instructions are further operable to cause the apparatus to: delete the another minimum loss segment recovery file and the minimum loss segment recovery file upon creation of the merged loss segment recovery file.
Clause 34. The temporal data recording apparatus of any of the aforementioned temporal data recording apparatus Clauses, wherein the minimum loss definition buffer comprises a plurality of five second buffer storage slots, and wherein the minimum loss segment is written to one of the plurality of five second buffer storage slots.
Clause 35. The temporal data recording apparatus of any of the aforementioned temporal data recording apparatus Clauses, wherein the storage latency reduction buffer comprises a plurality of five second buffer storage slots, and wherein the minimum loss segment is written to one of the plurality of five second buffer storage slots.
Clause 36. The temporal data recording apparatus of any of the aforementioned temporal data recording apparatus Clauses, wherein the temporal data is compressed temporal data, and wherein the instructions are further operable to cause the apparatus to: detect frame boundaries in the compressed temporal data; and define the minimum loss segment based on the detected frame boundaries to ensure the minimum loss segment contains only complete frames of the compressed temporal data.
Clause 37. The temporal data recording apparatus of any of the aforementioned temporal data recording apparatus Clauses, wherein the instructions are further operable to cause the apparatus to: write silent minimum loss segments to the minimum loss definition buffer during periods of silence in the received temporal data to maintain timing and synchronization of the temporal data stream.
Clause 38. The temporal data recording apparatus of any of the aforementioned temporal data recording apparatus Clauses, wherein the instructions are further operable to cause the apparatus to: execute writing of the minimum loss segment to the minimum loss definition buffer as a high-priority thread; and execute the parallel write operation as a lower-priority thread that yields to the high-priority thread in case of high computational resource demand.
Clause 39. The temporal data recording apparatus of any of the aforementioned temporal data recording apparatus Clauses, wherein the instructions are further operable to cause the apparatus to: adaptively adjust sizes of the minimum loss definition buffer and the storage latency reduction buffer based on available system resources and recording conditions.
Clause 40. A method for temporal data recording comprising: receiving temporal data; writing a minimum loss segment of the temporal data to a minimum loss definition buffer; executing a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.
Clause 41. The method of Clause 40, further comprising: deleting the minimum loss segment from the minimum loss definition buffer upon executing the parallel write operation.
Clause 42. The method of any of the aforementioned temporal data recording method Clauses, further comprising: writing another minimum loss segment of the temporal data to the minimum loss definition buffer; executing another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.
Clause 43. The method of any of the aforementioned temporal data recording method Clauses, further comprising: merging the another minimum loss segment and the minimum loss segment of the storage latency reduction buffer to create a merged loss segment recovery file upon determining that the storage latency reduction buffer satisfies a buffer completion threshold.
Clause 44. The method of any of the aforementioned temporal data recording method Clauses, further comprising: deleting the another minimum loss segment recovery file and the minimum loss segment recovery file upon creation of the merged loss segment recovery file.
Clause 45. The method of any of the aforementioned temporal data recording method Clauses, wherein the minimum loss definition buffer comprises a plurality of five second buffer storage slots, and wherein the minimum loss segment is written to one of the plurality of five second buffer storage slots.
Clause 46. The method of any of the aforementioned temporal data recording method Clauses, wherein the storage latency reduction buffer comprises a plurality of five second buffer storage slots, and wherein the minimum loss segment is written to one of the plurality of five second buffer storage slots.
Clause 47. The method of any of the aforementioned temporal data recording method Clauses, wherein the temporal data is compressed temporal data, and wherein the method further comprises: detecting frame boundaries in the compressed temporal data; and defining the minimum loss segment based on the detected frame boundaries to ensure the minimum loss segment contains only complete frames of the compressed temporal data.
Clause 48. The method of any of the aforementioned temporal data recording method Clauses, further comprising: writing silent minimum loss segments to the minimum loss definition buffer during periods of silence in the received temporal data to maintain timing and synchronization of the temporal data stream.
Clause 49. The method of any of the aforementioned temporal data recording method Clauses, further comprising: executing writing of the minimum loss segment to the minimum loss definition buffer as a high-priority thread; and executing the parallel write operation as a lower-priority thread that yields to the high-priority thread in case of high computational resource demand.
Clause 50. The method of any of the aforementioned temporal data recording method Clauses, further comprising: adaptively adjusting sizes of the minimum loss definition buffer and the storage latency reduction buffer based on available system resources and recording conditions.

1. An audio recording apparatus comprising at least one processor and a memory storing instructions that are operable, when executed by the processor, to cause the apparatus to:
receive audio data;
write a minimum loss segment of the audio data to a minimum loss definition buffer; and
execute a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.

2. The audio recording apparatus of claim 1, wherein the instructions are further operable, when executed by the processor, to cause the apparatus to:
delete the minimum loss segment from the minimum loss definition buffer upon executing the parallel write operation.

3. The audio recording apparatus of claim 1, wherein the instructions are further operable, when executed by the processor, to cause the apparatus to:
write another minimum loss segment of the audio data to the minimum loss definition buffer; and
execute another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.

4. The audio recording apparatus of claim 3, wherein the instructions are further operable, when executed by the processor, to cause the apparatus to:
merge the another minimum loss segment and the minimum loss segment of the storage latency reduction buffer to create a merged loss segment recovery file upon determining that the storage latency reduction buffer satisfies a buffer completion threshold.

5. The audio recording apparatus of claim 4, wherein the instructions are further operable, when executed by the processor, to cause the apparatus to:
delete the another minimum loss segment recovery file and the minimum loss segment recovery file upon creation of the merged loss segment recovery file.

6. The audio recording apparatus of claim 1, wherein the minimum loss definition buffer comprises a plurality of five second buffer storage slots, and wherein the minimum loss segment is written to one of the plurality of five second buffer storage slots.

7. The audio recording apparatus of claim 1, wherein the storage latency reduction buffer comprises a plurality of five second buffer storage slots, and wherein the minimum loss segment is written to one of the plurality of five second buffer storage slots.

8. The audio recording apparatus of claim 1, wherein the audio data is compressed audio data, and wherein the instructions are further operable, when executed by the processor, to cause the apparatus to:
detect frame boundaries in the compressed audio data; and
define the minimum loss segment based on the detected frame boundaries to ensure the minimum loss segment contains only complete frames of the compressed audio data.

9. The audio recording apparatus of claim 1, wherein the instructions are further operable, when executed by the processor, to cause the apparatus to:
write silent minimum loss segments to the minimum loss definition buffer during periods of silence in the received audio data to maintain timing and synchronization of the audio data.

10. A method for audio recording, comprising:
receiving audio data;
writing a minimum loss segment of the audio data to a minimum loss definition buffer;
executing a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.

11. The method of claim 10, further comprising:
deleting the minimum loss segment from the minimum loss definition buffer upon executing the parallel write operation.

12. The method of claim 10, further comprising:
writing another minimum loss segment of the audio data to the minimum loss definition buffer;
executing another parallel write operation upon completing the writing of the another minimum loss segment to the minimum loss definition buffer, wherein the another parallel write operation comprises (1) writing the another minimum loss segment to another minimum loss segment recovery file, and (2) writing the another minimum loss segment to the storage latency reduction buffer.

13. The method of claim 12, further comprising:
merging the another minimum loss segment and the minimum loss segment of the storage latency reduction buffer to create a merged loss segment recovery file upon determining that the storage latency reduction buffer satisfies a buffer completion threshold.

14. The method of claim 13, further comprising:
deleting the another minimum loss segment recovery file and the minimum loss segment recovery file upon creation of the merged loss segment recovery file.

15. The method of claim 10, wherein the minimum loss definition buffer comprises a plurality of five second buffer storage slots, and wherein the minimum loss segment is written to one of the plurality of five second buffer storage slots.

16. The method of claim 10, wherein the storage latency reduction buffer comprises a plurality of five second buffer storage slots, and wherein the minimum loss segment is written to one of the plurality of five second buffer storage slots.

17. The method of claim 10, wherein the audio data is compressed audio data, and wherein the method further comprises:
detecting frame boundaries in the compressed audio data; and
defining the minimum loss segment based on the detected frame boundaries to ensure the minimum loss segment contains only complete frames of the compressed audio data.

18. The method of claim 10, further comprising:
writing silent minimum loss segments to the minimum loss definition buffer during periods of silence in the received audio data to maintain timing and synchronization of the audio data.

19. The method of claim 10, further comprising:
executing writing of the minimum loss segment to the minimum loss definition buffer as a high-priority thread; and
executing the parallel write operation as a lower-priority thread that yields to the high-priority thread in case of high computational resource demand.

20. The method of claim 10, further comprising:
adaptively adjusting sizes of the minimum loss definition buffer and the storage latency reduction buffer based on available system resources and recording conditions.

21. A non-transitory computer-readable medium storing instructions that, when executed by a processor, cause the processor to perform operations comprising:
receiving audio data;
writing a minimum loss segment of the audio data to a minimum loss definition buffer;
executing a parallel write operation upon completing the writing of the minimum loss segment to the minimum loss definition buffer, wherein the parallel write operation comprises (1) writing the minimum loss segment to a minimum loss segment recovery file, and (2) writing the minimum loss segment to a storage latency reduction buffer.
